(19) United States
(12) Patent Application Publication
(10) Pub. No.: US 2013/0050082 A1
(43) Pub. Date: Feb. 28, 2013

(54) MOUSE AND METHOD FOR DETERMINING MOTION OF A CURSOR

(71) Applicant: Tung-Ming Wu, New Taipei City (TW)

(72) Inventor: Tung-Ming Wu, New Taipei City (TW)

(21) Appl. No.: 13/272,203

(22) Filed: Oct. 12, 2011

(30) Foreign Application Priority Data
Aug. 22, 2011 (TW) 100130022

(51) Int. Cl. G06F 3/033; G09G 5/08

(52) U.S. Cl. 345/163; 345/157

(57) ABSTRACT

A method for determining motion of a cursor is disclosed in the present invention. The method includes executing an initial amendment, detecting a first physic quantity by a first G sensor, controlling displacement of the cursor according to the first physic quantity and the initial amending value by a processor, detecting a second physic quantity and a third physic quantity by a second G sensor and a third G sensor according to detection of the first G sensor, and outputting a controlling signal according to detection of the second G sensor and the third G sensor by the processor.

### BACKGROUND OF THE INVENTION

1. Field of the Invention

The present invention relates to a mouse and a method for determining motion of a cursor, and more particularly, to a mouse capable of operating in 3D space and a method for determining motion of a cursor.

2. Description of the Prior Art

Conventional mouse includes a roller mouse and an optical mouse. The roller mouse and the optical mouse have to be put on a table for operation, such as putting on a mouse pad or a flat tabletop, and a user can accurately control displacement and functions of a cursor of the mouse on the display interface. That is to say, the conventional mouse is operated on 2D plane. Thus, design of an air mouse capable of operating in 3D air for increasing convenience and flexibility is an important issue in the computer industry.

### SUMMARY OF THE INVENTION

The present invention provides a mouse capable of operating in 3D space and a method for determining motion of a cursor for solving above drawbacks.

According to the claimed invention, a method for determining motion of a cursor on a display interface includes executing an initial amendment; detecting a first physical quantity by a first G sensor; controlling displacement of the cursor according to the first physical quantity and an initial amending value by a processor; detecting a second physical quantity and a third physical quantity respectively by a second G sensor and a third G sensor according to detection of the first G sensor; and outputting a controlling signal according to detection of the second G sensor and the third G sensor by the processor.

According to the claimed invention, controlling the displacement of the cursor according to the first physical quantity and the initial amending value by the processor includes outputting the controlling signal via a transmitter by the processor, and receiving the controlling signal by a receiver so as to utilize the controlling signal and the initial amending value to control the displacement of the cursor on the display interface.

According to the claimed invention, controlling the displacement of the cursor according to the first physical quantity and the initial amending value by the processor further includes controlling the displacement of the cursor corresponding to the first physical quantity according to the first physical quantity and the initial amending value by the processor when the first physical quantity is not equal to zero.

According to the claimed invention, controlling the displacement of the cursor according to the first physical quantity and the initial amending value by the processor further includes stopping the displacement of the cursor by the processor when the first physical quantity is equal to zero.

According to the claimed invention, detecting the second physical quantity and the third physical quantity respectively by the second G sensor and the third G sensor according to the detection of the first G sensor includes detecting the second physical quantity and the third physical quantity respectively by the second G sensor and the third G sensor when the first physical quantity is equal to zero.

According to the claimed invention, outputting the controlling signal according to the detection of the second G sensor and the third G sensor by the processor includes outputting the controlling signal according to the second physical quantity or the third physical quantity by the processor when determining that the second physical quantity and the third physical quantity are generated simultaneously, wherein the second physical quantity represents a click signal of a mouse left key, and the third physical quantity represents a click signal of a mouse right key.

According to the claimed invention, outputting the controlling signal according to the detection of the second G sensor and the third G sensor by the processor further includes outputting the controlling signal according to the second physical quantity or the third physical quantity by the processor when determining that the second physical quantity and the third physical quantity are simultaneously generated once again, wherein the second physical quantity represents a positive signal of a mouse roller, and the third physical quantity represents a negative signal of the mouse roller.

According to the claimed invention, outputting the controlling signal according to the detection of the second G sensor and the third G sensor by the processor includes outputting the controlling signal according to the second physical quantity or the third physical quantity by the processor when determining that the second physical quantity and the third physical quantity are generated simultaneously, wherein the second physical quantity represents a positive signal of a mouse roller, and the third physical quantity represents a negative signal of the mouse roller.

According to the claimed invention, outputting the controlling signal according to the detection of the second G sensor and the third G sensor by the processor further includes outputting the controlling signal according to the second physical quantity or the third physical quantity by the processor when determining that the second physical quantity and the third physical quantity are simultaneously generated once again, wherein the second physical quantity represents a click signal of a mouse left key, and the third physical quantity represents a click signal of a mouse right key.

According to the claimed invention, outputting the controlling signal according to the detection of the second G sensor and the third G sensor by the processor further includes outputting the controlling signal via a transmitter by the processor; and receiving the controlling signal by a receiver so as to utilize the controlling signal to output the motion corresponding to a click signal from a mouse right key or from a mouse left key, or further corresponding to a positive signal or a negative signal from a mouse roller.

According to the claimed invention, a mouse includes a first G sensor for detecting a first physical quantity; a second G sensor for detecting a second physical quantity; a third G sensor for detecting a third physical quantity; and a processor electrically connected to the first G sensor, the second G sensor and the third G sensor for controlling displacement of a cursor on a display interface according to the first physical quantity and an initial amending value, and further for outputting a controlling signal corresponding to the second physical quantity and the third physical quantity according to detection of the first G sensor.

The mouse of the present invention can be disposed on the user hand. The user can move the wrist and shake the fingers to simulate the controlling signals of the mouse roller and the mouse left/right keys, so as to output the command the same as the conventional mouse. Therefore, the mouse of the present can be operated in the air (the 3D space) and creates completely new operating revolution.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a mouse according to an embodiment of the present invention.

FIG. 2 is diagram of the mouse according to the embodiment of the present invention.

FIG. 3 is a flow chart of signal determination of the mouse according to the embodiment of the present invention.

### DETAILED DESCRIPTION

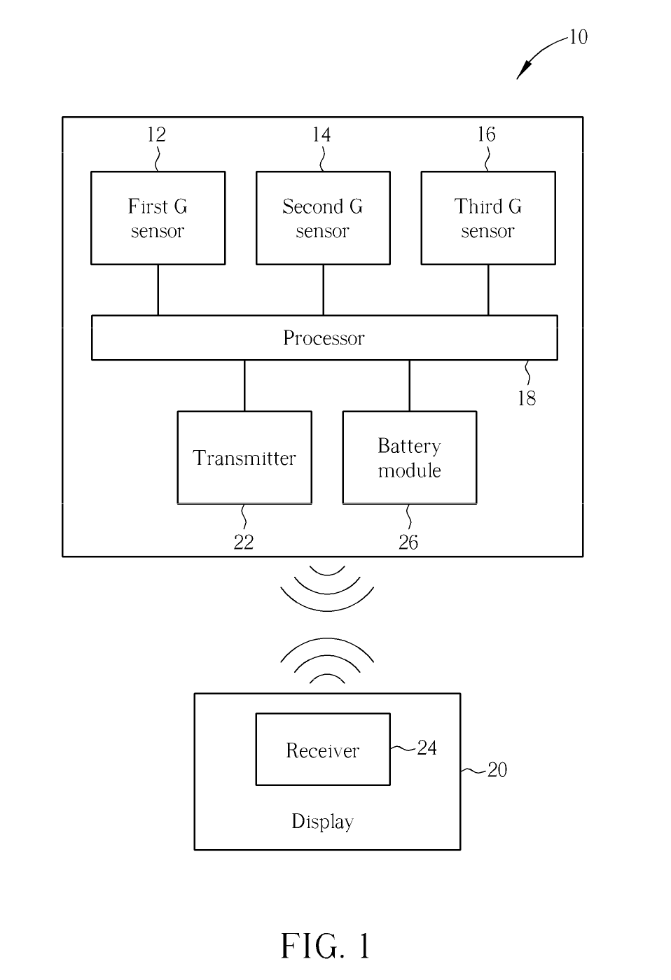

Please refer to FIG. 1. FIG. 1 is a functional block diagram of a mouse 10 according to an embodiment of the present invention. A conventional optical mouse or a conventional roller mouse moves relative to a plane (such as a tabletop) for adjusting its cursor. The mouse 10 of the present invention can be operated in 3D space. The mouse 10 can be set on a wrist and fingers, and a user can control displacement of the cursor by moving the wrist and the fingers. The mouse 10 includes a first G sensor 12 for detecting a first physical quantity, a second G sensor 14 for detecting a second physical quantity, a third G sensor 16 for detecting a third physical quantity, and a processor 18 electrically connected to the first G sensor 12, the second G sensor 14 and the third G sensor 16. For example, the processor 18 can be coupled with the G sensors via the serial communication bus. The first G sensor 12 (or the second G sensor 14, the third G sensor 16) can be for detecting an acceleration, which means the first physical quantity (or the second physical quantity, the third physical quantity) can be an axial acceleration magnitude. The G sensor can be selectively configured to output a detecting signal (or an actuating signal) when detecting an acceleration greater than a threshold limit value. For example, the G sensor can be set to output the detecting signal (or the actuating signal) when detecting the acceleration as 2G, 4G, 8G or 16G according to user demand, so as to prevent the mouse 10 from outputting the controlling signal of the cursor accidentally.

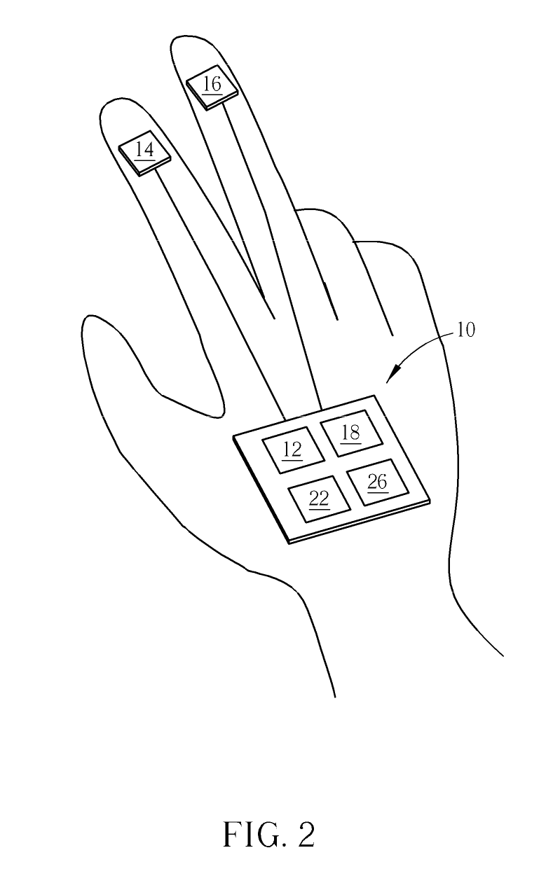

Please refer to FIG. 2. FIG. 2 is diagram of the mouse 10 according to the embodiment of the present invention. The mouse 10 may be look like a groove. The first G sensor 12 can be disposed around the wrist, the second G sensor 14 and the third G sensor 16 can be respectively disposed on tops of a forefinger and a middle finger, such as on fingertips. Trigger value of the G sensors can be set according to the user demand. For example, the trigger value of the first G sensor 12 can be set as 2G, and the trigger values of the second G sensor 14 and the third G sensor 16 can be set as 4G. When the user shakes hands, and the first physical quantity detected by the first G sensor 12 is greater than 2G, the processor 18 can output the corresponding controlling signal according to the first physical quantity. When the user shakes the forefinger (or the middle finger), and the acceleration detected by the second G sensor 14 (or the third G sensor 16) disposed on the fingertip is greater than 4G, the processor 18 can output the corresponding controlling signal according to the second physical quantity (or the third physical quantity). Therefore, the mouse 10 of the present invention can be disposed on the hand, and the user can shake the wrist or the fingers for simulating functions of the conventional mouse, so as to operate 3D application.

Generally, the mouse 10 can be for controlling motion of the cursor on a display 20. As shown in FIG. 1, the mouse 10 can further includes a transmitter 22 electrically connected to the processor 18, a receiver 24 electrically connected to the display 20, and a battery module 26 electrically connected to the processor 18. When the processor 18 outputs the controlling signal, the transmitter 22 can receive the controlling signal, and then can further encode, translate and encrypt the controlling signal to transmit toward the receiver 24. The display 20 can execute the motion of the cursor according to the controlling signal, such as the displacement, clicks or other operation when receiving the controlling signal outputted from the mouse 10 via the receiver 24. It should be mentioned that communication between the transmitter 22 and the receiver 24 can be a wire communication or a wireless communication. In the embodiment of the present invention, the transmitter 22 can be a wireless transmitter, such as a Bluetooth transmitter, so the receiver 24 can be a wireless receiver accordingly. In addition, when the transmitter 22 is the wireless transmitter, the battery module 26 can be the power supply of the processor 18, so as to increase convenience of the mouse 10.

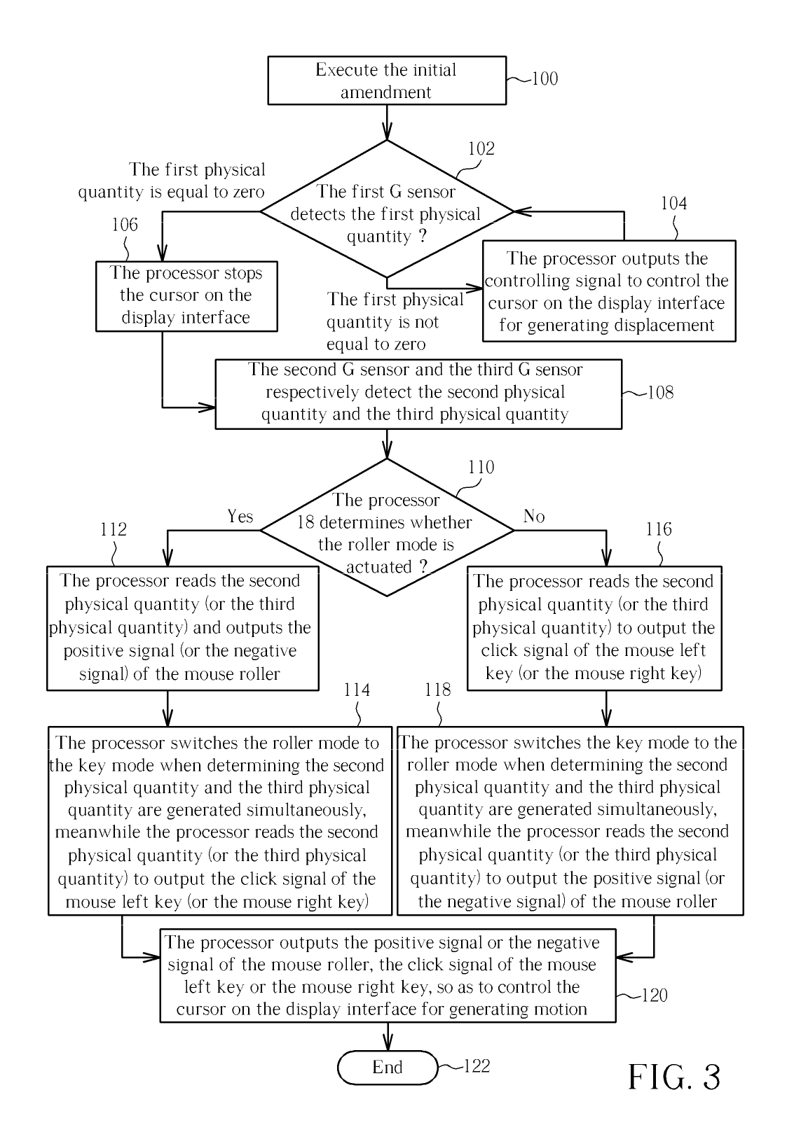

Please refer to FIG. 3. FIG. 3 is a flow chart of signal determination of the mouse 10 according to the embodiment of the present invention. The method includes follows:

Step 100: Execute an initial amendment, and generate an initial amending value for reference.

Step 102: The first G sensor 12 detects the first physical quantity. If the first physical quantity is not equal to zero, execute step 104; if the first physical quantity is equal to zero, execute step 106.

Step 104: The processor 18 outputs the controlling signal via the transmitter 22 according to the first physical quantity and the initial amending value. The receiver 24 receives the controlling signal and utilizes the controlling signal to control a cursor on an interface of the display 20, so as to generate the corresponding displacement, then execute step 102.

Step 106: The processor 18 stops the cursor on the interface of the display 20, and execute step 108.

Step 108: The second G sensor 14 and the third G sensor 16 respectively detect the second physical quantity and the third physical quantity.

Step 110: The processor 18 determines whether a roller mode (or a predetermined mode) is actuated. If yes, execute step 112; if not, execute step 116.

Step 112: The processor 18 reads the second physical quantity and outputs a positive signal of a mouse roller, or the processor 18 reads the third physical quantity and outputs a negative signal of the mouse roller, then execute step 114.

Step 114: The processor 18 switches the roller mode to a key mode when determining the second physical quantity and the third physical quantity are generated simultaneously, meanwhile the processor 18 reads the second physical quantity to output a click signal of a mouse left key, or the processor 18 reads the third physical quantity to output a click signal of a mouse right key, then execute step 120.

Step 116: The processor 18 reads the second physical quantity to output the click signal of the mouse left key, or the processor 18 reads the third physical quantity to output the click signal of the mouse right key, then execute step 118.

Step 118: The processor 18 switches the key mode to the roller mode when determining the second physical quantity and the third physical quantity are generated simultaneously, meanwhile the processor 18 reads the second physical quantity to output the positive signal of the mouse roller, or the processor 18 reads the third physical quantity to output the negative signal of the mouse roller, then execute step 120.

Step 120: The processor 18 outputs the positive signal of the mouse roller, the negative signal of the mouse roller, the click signal of the mouse left key or the click signal of the mouse right key via the transmitter 22. The receiver 24 receives the controlling signal and utilizes the controlling signal to control the cursor on the interface of the display 20 for generating motion corresponding to the controlling signal.

Step 122: The end.

Detail description is introduced as follows. First, the processor 18 of the mouse 10 execute the initial amendment when starts, so as to ensure parameters of the first G sensor 12 relative to the display 20. Because the first G sensor 12 can be disposed on the wrist for controlling positions of the cursor on the interface of the display 20, so the initial amendment can be for calculating relative positions of the first G sensor 12 and the display 20 when the mouse 10 starts. After, the first G sensor 12 is actuated to detect the first physical quantity. As the first physical quantity is not equal to zero, the wrist of the user moves relative to the display 20, which means the displacement of the cursor on the interface of the display 20 can be controlled. At this time, the processor 18 can output the controlling signal according to the first physical quantity and the initial amending value, so as to drive the corresponding displacement of the cursor.

For example, a position of the mouse 10 can be set as an initial position of the cursor on the interface of the display 20 by the processor 18 when executing the initial amendment. By shaking hands to move the processor 18 relative to the display 20, the processor 18 can drive the cursor to move along X axis and Y axis on the interface of the display 20 according to the initial position of the cursor on the interface of the display 20. In the embodiment of the present invention, the mouse 10 can transmit the signal by wireless communication technology, so the processor 18 outputs the wireless controlling signal via the transmitter 22, and the receiver 24 coupled with the display 18 can receive the wireless controlling signal. Thus, the user can casually move hands in the air to adjust the position of the cursor on the interface of the display 20 by the mouse 10.

On the other hand, the wrist is motionless when the first physical quantity detected by the first G sensor 12 is equal to zero, so the cursor stops, and then the second G sensor 14 and the third G sensor 16 can be actuated to respectively detect the second physical quantity and the third physical quantity immediately. The processor 18 determines whether the mouse 10 is at the roller mode or the key mode when the second G sensor 14 and the third G sensor 16 are actuated, so as to identify commands of the second physical quantity and the third physical quantity. For example, when the processor 10 determines the mouse 10 is at the roller mode, the user can move the forefinger and the middle finger to simulate motion of the roller. As shaking the forefinger, the second G sensor 14 can detect an acceleration magnitude to generate the second physical quantity, and the processor 18 can reads the second physical quantity to output the positive signal of the mouse roller. In addition, as shaking the middle finger, the processor 18 can reads the third physical quantity detected by the third G sensor 16 to output the negative signal of the mouse roller.

On the other hand, the mouse 10 is at the key mode when the processor 10 determines the roller mode is not actuated. The processor 18 can read the second physical quantity detected by the second G sensor 14 to output the click signal of the mouse left key, or can read the third physical quantity detected by the third G sensor 16 to output the click signal of the mouse right key. However, the second physical quantity can be transformed into the click signal of the mouse right key, and the third physical quantity can be transformed into the click signal of the mouse left key, which is adjusted according to habitually hands of the user (such as the southpaw or not). Therefore, the processor 18 of the present invention can simulate the signals generated by the second G sensor 14 and the third G sensor 16 as the controlling signals of the mouse left key or the mouse right key, or the positive motion or the negative motion of the mouse roller according to setting modes of the mouse 10. Because amounts of the G sensors are less than variation of the controlling signals, the mouse 10 has a function for switching operation from the roller mode to the key mode. In the embodiment of the present invention, the mouse 10 can set a situation, the second physical quantity and the third physical quantity are generated simultaneously once or more, being the controlling signal to switch operating modes, so that the user can easily switch the operating modes of the mouse 10 from the roller mode to the key mode according to demands. For example, As the roller mode is a predetermined mode, the mouse 10 can switch its operating mode from the roller mode to the key mode (or starts the key mode) when detecting that the second physical quantity and the third physical quantity are generated simultaneously at the first time; when the second physical quantity and the third physical quantity are simultaneously generated once again (or the processor 18 simultaneously detects the second physical quantity and the third physical quantity are generated twice), the mouse 10 can switch the operating mode from the key mode to the roller mode (or starts the roller mode); when the processor 18 simultaneously detects the second physical quantity and the third physical quantity are generated at the third time, the mouse 10 can switch the operating mode from the roller mode to the key mode (or starts the key mode). Thus, the mouse 10 of the present invention can determine whether the key mode or the roller mode is actuated by detection of generating frequency of the second physical quantity and the third physical quantity.

When the mouse 10 is at the roller mode, and the second G sensor 14 and the third G sensor 16 of the mouse 10 respectively outputs the signal, the second physical quantity and the third physical quantity can respectively represent the positive signal and the negative signal of the mouse roller. As the second G sensor 14 and the third G sensor 16 output the signals at the same time, the mouse 10 can be switched from the roller mode to the key mode by the processor 18, and then the signals outputted from the second G sensor 14 and the third G sensor 16 can respectively represent the click signals of the mouse left key and the mouse right key. When the processor 18 detects that the second G sensor 14 and the third G sensor 16 simultaneously output the signals again, the mouse 10 can be switched from the key mode to the roller mode by the processor 18. Thus, the cursor on the interface of the display 20 can be moved by utilizing the first G sensor 12, and the second G sensor 14 and the third G sensor 16 can control a web browser reel on the interface of the display 20 by simulating the rolling signals of the roller mode. Furthermore, the mouse 10 can be switched to the key mode, so that the second G sensor 14 and the third G sensor 16 can respectively output the click signals of the mouse left key and the mouse right key for simulating controlling function of the conventional roller mouse or the conventional optical mouse.

It should be mentioned that the threshold value of the G sensors of the mouse 10 can be set according to user demand, such as for determining whether the user plans to independently control the second G sensor 14 or the third G sensor 16 to output the controlling signals of the mouse roller or the mouse keys, or plans to switch the operating modes (the roller mode and the key mode) by simultaneously driving the second G sensor 14 and the third G sensor 16. For example, the second G sensor 14 and the third G sensor 16 can be set to respectively output the corresponding controlling signals of the mouse roller or the mouse keys when detecting the acceleration magnitude is over 2G, and can further be set to simultaneously output the controlling signals for switching the operating mode when detecting the acceleration magnitude is over 4G. Therefore, the user can slight shake the forefinger or the middle finger to control rolling of the mouse roller or clicking of the mouse left/right keys, and can further simultaneously move the forefinger and the middle finger violently to switch the mouse 10 between the roller mode and the key mode.

Comparing to the prior art, the mouse of the present invention can be disposed on the user hand. The user can move the wrist and shake the fingers to simulate the controlling signals of the mouse roller and the mouse left/right keys, so as to output the command the same as the conventional mouse. Therefore, the mouse of the present can be operated in the air (the 3D space) and creates completely new operating revolution.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for determining motion of a cursor on a display interface comprising:
executing an initial amendment;
detecting a first physical quantity by a first G sensor;
controlling displacement of the cursor according to the first physical quantity and an initial amending value by a processor;
detecting a second physical quantity and a third physical quantity respectively by a second G sensor and a third G sensor according to detection of the first G sensor; and
outputting a controlling signal according to detection of the second G sensor and the third G sensor by the processor.

2. The method of claim 1, wherein controlling the displacement of the cursor according to the first physical quantity and the initial amending value by the processor comprises:
outputting the controlling signal via a transmitter by the processor; and
receiving the controlling signal by a receiver so as to utilize the controlling signal and the initial amending value to control the displacement of the cursor on the display interface.

3. The method of claim 1, wherein controlling the displacement of the cursor according to the first physical quantity and the initial amending value by the processor further comprises:
controlling the displacement of the cursor corresponding to the first physical quantity according to the first physical quantity and the initial amending value by the processor when the first physical quantity is not equal to zero.

4. The method of claim 1, wherein controlling the displacement of the cursor according to the first physical quantity and the initial amending value by the processor further comprises:
stopping the displacement of the cursor by the processor when the first physical quantity is equal to zero.

5. The method of claim 1, wherein detecting the second physical quantity and the third physical quantity respectively by the second G sensor and the third G sensor according to the detection of the first G sensor comprises:
detecting the second physical quantity and the third physical quantity respectively by the second G sensor and the third G sensor when the first physical quantity is equal to zero.

6. The method of claim 1, wherein outputting the controlling signal according to the detection of the second G sensor and the third G sensor by the processor comprises:
outputting the controlling signal according to the second physical quantity or the third physical quantity by the processor when determining that the second physical quantity and the third physical quantity are generated simultaneously, wherein the second physical quantity represents a click signal of a mouse left key, and the third physical quantity represents a click signal of a mouse right key.

7. The method of claim 6, wherein outputting the controlling signal according to the detection of the second G sensor and the third G sensor by the processor further comprises:
outputting the controlling signal according to the second physical quantity or the third physical quantity by the processor when determining that the second physical quantity and the third physical quantity are simultaneously generated once again, wherein the second physical quantity represents a positive signal of a mouse roller, and the third physical quantity represents a negative signal of the mouse roller.

8. The method of claim 1, wherein outputting the controlling signal according to the detection of the second G sensor and the third G sensor by the processor comprises:
outputting the controlling signal according to the second physical quantity or the third physical quantity by the processor when determining that the second physical quantity and the third physical quantity are generated simultaneously, wherein the second physical quantity represents a positive signal of a mouse roller, and the third physical quantity represents a negative signal of the mouse roller.

9. The method of claim 8, wherein outputting the controlling signal according to the detection of the second G sensor and the third G sensor by the processor further comprises:
outputting the controlling signal according to the second physical quantity or the third physical quantity by the processor when determining that the second physical quantity and the third physical quantity are simultaneously generated once again, wherein the second physical quantity represents a click signal of a mouse left key, and the third physical quantity represents a click signal of a mouse right key.

10. The method of claim 1, wherein outputting the controlling signal according to the detection of the second G sensor and the third G sensor by the processor further comprises:
outputting the controlling signal via a transmitter by the processor; and
receiving the controlling signal by a receiver so as to utilize the controlling signal to output the motion corresponding to a click signal from a mouse right key or from a mouse left key, or further corresponding to a positive signal or a negative signal from a mouse roller.

11. A mouse comprising:
a first G sensor for detecting a first physical quantity;
a second G sensor for detecting a second physical quantity;
a third G sensor for detecting a third physical quantity; and
a processor electrically connected to the first G sensor, the second G sensor and the third G sensor for controlling displacement of a cursor on a display interface according to the first physical quantity and an initial amending value, and further for outputting a controlling signal corresponding to the second physical quantity and the third physical quantity according to detection of the first G sensor.

12. The mouse of claim 11, further comprising:
a transmitter electrically connected to the processor, the processor being for outputting the controlling signal via the transmitter; and
a receiver electrically connected to the display for receiving the controlling signal outputted from the transmitter, so as to control motion of the cursor on the display interface.

13. The mouse of claim 12, wherein the transmitter is a wireless transmitter.

14. The mouse of claim 11, wherein the processor controls the displacement of the cursor corresponding to the first physical quantity according to the first physical quantity and the initial amending value when the first physical quantity is not equal to zero.

15. The mouse of claim 11, wherein the processor stops the displacement of the cursor when the first physical quantity is equal to zero.

16. The mouse of claim 11, wherein the processor outputs the corresponding controlling signal according to the second physical quantity and the third physical quantity when the first physical quantity is equal to zero.

17. The mouse of claim 16, wherein the processor represents the controlling signal corresponding to the second physical quantity as a click signal of a mouse left key, and further represents the controlling signal corresponding to the third physical quantity as a click signal of a mouse right key when determining that the second physical quantity and the third physical quantity are generated simultaneously.

18. The mouse of claim 17, wherein the processor further represents the controlling signal corresponding to the second physical quantity as a positive signal of a mouse roller, and further represents the controlling signal corresponding to the third physical quantity as a negative signal of the mouse roller when determining that the second physical quantity and the third physical quantity are simultaneously generated once again.

19. The mouse of claim 11, wherein the first G sensor is electrically connected to the processor via a serial communication bus.

20. The mouse of claim 11, further comprising:
a battery module electrically connected to the processor.
